(19) United States
(12) Patent Application Publication
(10) Pub. No.: US 2012/0158545 A1
(43) Pub. Date: Jun. 21, 2012

(54) MOBILE ON-THE-SPOT SHOPPING AND PAYMENTS

(75) Inventors: Simon Chen, Fremont, CA (US); Rakesh S. Bhakta, Austin, TX (US); Timothy A. Domke, Mountain View, CA (US)

(73) Assignee: EBAY, INC., San Jose, CA (US)

(21) Appl. No.: 13/325,540

(22) Filed: Dec. 14, 2011

Related U.S. Application Data
(60) Provisional application No. 61/425,170, filed on Dec. 20, 2010.

(51) Int. Cl. G06Q 30/06

(52) U.S. Cl. 705/26.61

(57) ABSTRACT

A merchant uploads products or services to create an online store for purchases. The merchant also specifies the physical location of its store or stores or the service provider may determine a store location based on the location of a merchant device. When a user is near at least one of the stores, the user is presented with items available for purchase through any nearby merchants. The user can then make the purchase through the mobile device. The service provider may approve the transaction based, in part, on the location of the merchant and the user. Thus merchants that do not have a website can take advantage of online transactions. Mobile sellers, such as food trucks, can also use this idea to create stores and have users be notified when they are nearby.

### CROSS REFERENCE TO RELATED APPLICATION

The present application is related to and claims priority to U.S. Provisional Patent Appl. Ser. No. 61/425,170, filed Dec. 20, 2010, which is incorporated by reference in its entirety.

### BACKGROUND

Typical shopping or payment transactions are performed either in-person or online. For in-person transactions, consumers select items and make the purchase (payment) at the physical location or point of sale (POS). Payment can be made by giving the merchant cash, a credit card, a debit card, or a check. After payment, the consumer takes possession of the purchased items.

For online transactions, consumers typically place items into a cart on a merchant or retailer website and make a payment directly to the merchant or through a payment provider service, such as PayPal, Inc. of San Jose, Calif. For the former, payment can be made by providing credit card or bank account information. For the latter, the consumer may access an account managed by the payment provider, authorize payment, and have the payment sent to the merchant by the payment provider. The purchased items are then typically shipped to the consumer or the consumer picks up the items at a designated location, such as a store.

Both types of transactions provide advantages and disadvantages for consumers and sellers or merchants. For consumers performing in-person transactions, there is greater inconvenience since the consumer has to go to the POS instead of just shopping online at their house, work, or through their mobile device. For online transactions, the user typically does not receive the purchased goods immediately upon purchase, and the user cannot first inspect the items to be purchased.

For merchants selling in-person, there may be reduced sales since there may be far fewer in-store consumers than potential consumers online. For online transactions, many small or medium sized merchants may not have websites, resulting in the inability to attract consumers through the web and lost sales.

Therefore, there is a need for a way to shop that overcomes the disadvantages of conventional methods discussed above.

### SUMMARY

A service provider, such as PayPal, Inc. of San Jose, Calif., utilizes the location of both the user (or consumer) and the merchant to combine advantages of both online and in-person transactions.

In one embodiment, a merchant uploads products or services to a service provider site, such as eBay, Inc. of San Jose, Calif., to create an online store for purchases, even if the merchant does not have its own webpage or online site. The merchant also specifies the physical location of its store or stores or the service provider may determine a store location based on the location of a merchant device. When a user logs into the service provider site, such as through the user's mobile device, the service provider determines the location of the user and any stores that in the vicinity of the user. The user is presented with items available for purchase through any nearby merchants. The user can then make the purchase through the mobile device or other means and receive the purchased items. The service provider may approve the transaction based, in part, on the location of the merchant and the user. Thus merchants that do not have a website can take advantage of online transactions. Mobile sellers, such as food trucks, can also use this idea to increase sales.

In another embodiment, merchants can set up “virtual” stores at locations with limited space. A virtual store may be defined, in one embodiment, as an online store with no physical location, e.g., no permanent physical location. The virtual store or “pop-up” store enables an online merchant to set up a location to sell items and services virtually anywhere without the need for a brick-and-mortar store. A merchant registers with the service provider and provides the location of its virtual store (either manually or automatically through a merchant device location), along with a list of items/services available for purchase, if desired. When a user nears a location of a virtual store, such as at a train terminal or bus station, the user may see signs or other visual indicators of items that can be purchased, such as digital travel guides, restaurant guides, etc. The user can make the payment and receive the digital good on the user's mobile device through the mobile device carrier. The payment can be made through a simplified flow on the user device or a simple “bump.” The user's mobile device then transmits location information, device identifier, and/or any other needed information to the service provider, which uses this information to process the payment request and transfer of the purchase.

In one embodiment, the “merchant” can be a charity, where the virtual store is a donation point. In this case, the user may be presented with a list of donation locations or charities nearby, which the user may select from the user device. The user can then make a donation or payment to a selected charity.

These and other features and advantages of the present disclosure will be more readily apparent from the detailed description of the embodiments set forth below.

### BRIEF DESCRIPTION OF THE DRAWINGS

FIG. 1 is a flowchart showing a method of using user and merchant location for purchases at mobile stores according to one embodiment;

FIG. 2 is a flowchart showing a method of using merchant and user location for purchase with unmanned “stores” according to another embodiment;

FIG. 3 is a block diagram of a networked system suitable for implementing the processes described herein according to an embodiment; and

FIG. 4 is a block diagram of a computer system suitable for implementing one or more components in FIG. 3 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

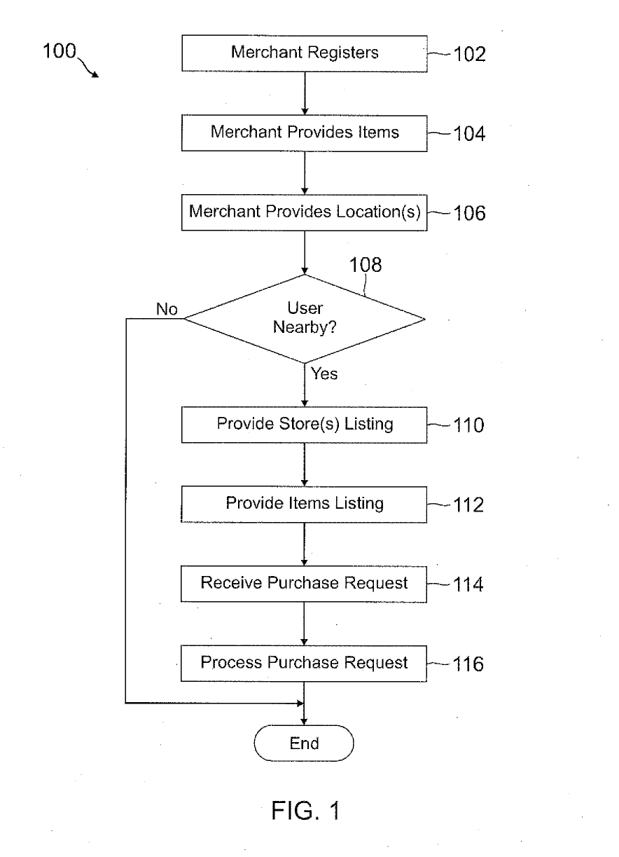

FIG. 1 is a flowchart 100 showing a method of using user and merchant location for payments, according to one embodiment. At step 102, the merchant registers with a service provider, such as eBay or PayPal. Registration may include signing up for the service and agreeing to any terms required by the service provider, such as through a merchant device. In one embodiment, the merchant device is a mobile computing device, such as a smart phone, a PC, or a computing tablet. In other embodiments, registration may be done completely through the merchant device, partially through the merchant device, or without using the merchant device, such as through a phone call or in-person visit to a representative of the service provider.

The merchant may be requested to provider specific information for registration, such as, but not limited to, a merchant name, type of goods/services offered, address, location(s) of planned sales, phone number, email address, website address (if applicable), social security or tax ID number, a user name for the account, and a password or PIN for the account. The type of information may depend on whether the user already has an account with the service provider. Even if the merchant has an account, the merchant may be requested to register for this particular service, such as by providing specific information and agreeing to certain terms and conditions. Requested information may be entered through the merchant device or other means, including voice or manual key entry. Once all the requested information is received and confirmed, the service provider may create an account for the merchant and/or offer the service to the merchant.

After registration, the merchant may provide the service provider a list of items available for purchase at step 104. Items may include services, products, donations, and any other tangible or intangible offering that a user can make a payment for. Item information may include providing descriptions, item identifiers, prices, quantity available, photos/images, and any other desired information. The merchant may communicate the information in various ways, including through a merchant portal offered by the service provider, email, text, a phone call, fax, or any suitable means. In one embodiment, the merchant may provide any information desired by the merchant and in any format. In other embodiments, the service provider may require specific information and/or formats. For example, if an item is clothing, the service provider may have specific fields that will be required to be filled in, such as by the merchant selecting from a drop-down menu or the merchant manually entering information through the merchant device, either by voice or key entry.

Next, at step 106, the merchant provides location(s) where the items provided at step 104 are available for user purchase. Note that steps 104 and 106 can be combined or performed in a different order. Location information may include GPS coordinates or a street address, including city, state, and/or zip code. The merchant may manually enter a location through a merchant device, where the location is then communicated to the service provider. This may be useful if the user is setting up a store at a location different than the merchant's present location (e.g., the location of the merchant device). The location information may also be obtained by the service provider using location information from a merchant device. For example, if the merchant is a mobile merchant, such as a food truck or ticket vendor, the service provider may use the location (e.g., GPS coordinates) of the merchant device where the merchant store is located. This allows the service provider to obtain location information from mobile merchants without the merchants having to manually enter location information each time they move the store to a new location. Mobile merchants may also be able to allow users to “follow” them as they move from location to location, such as through text messages to the user device. Such virtual or pop-up stores enable a merchant to set up a location to sell items and services nearly anywhere, such as a parking lot, a park, etc., without the need for any physical store front. All that may be needed is an indication that items may be purchased, which may include simply a sign or banner and a sales person.

The above provides the needed information about the merchant to the service provider in order for the service provider to notify the user when the user is in the area or nearby one or more stores of one or more merchants. Thus, steps 102-106 may be performed only once when the merchant sets up the “store” with the service provider. One or more of steps 102, 104, and 106 may be performed subsequently as needed, such as when available items change, the merchant location changes, etc.

Once the merchant has its store set up with the service provider, the following steps may be performed to allow users to purchase items from the store. At step 108, the service provider determines whether a user is near the store location. The user location may be determined by the service provider from location information transmitted or received from the user's mobile device. For example, the use may allow the service provider to use location information from the user device or the user may enter a specific location, such as an address, and transmit that location to the service provider. In this situation, the user may want to see a list of merchants nearby where the user will be at, but is not currently at.

Once the user location is determined, the service provider determines whether that location is near one or more merchant stores. “Nearby” may be defined by the user, the service provider, the merchant, and/or be dependent on the type of location. For example, the user may select a “nearby” distance, such as within ½ mile. A merchant may want a longer “nearby” distance, such as 2 miles, to attract or target more potential customers. The distance may be determined by the service provider and may vary depending on location. For example, a dense area, such as a shopping mall or swap meet, may have a shorter distance than rural or sparsely populated areas. In another example, the system determines what is “nearby,” based on the user's location within a store or area and can change as the user moves. A “nearby” area may be different if the user is in a small coffee shop as opposed to a large museum. Thus, the distance from the user may be determined in any number of ways.

Once the user is within a distance (nearby) to a merchant location, the user is provided with the store(s) that are nearby at step 110. This could be one or many stores. The listing may be provided on the user mobile device in any form, including on a map, a list, icons, etc. Information about the stores may also be provided, such as store name, type of store, store address, store hours, store phone number, user ratings, and any other suitable information.

The user may then select one or more stores, such as by tapping, clicking on, or other means. Selecting a store may allow the user to view more information about store, such as items available for purchase. As such, item listings from the selected stores are then shown on the user's device, at step 112. Again, this can be in any format, such as a listing by category, item descriptions, including price, quantity available, photo, etc., and/or listing by price. Note that in some embodiments, the user does not need to select a store, as item listings of all nearby stores will be shown to the user. In another embodiment, a single store, such as selected by the service provider or the user, is shown, along with items for that store. The user then has the option of zooming out to see other stores nearby and their associated items.

The use can then select items the user wishes to purchase or make payments for (such as a charity). The selection may be accomplished by tapping or checking links or buttons associated with desired items on the user's mobile device. For example, the user may see a “Add to Cart,” “Purchase,” or similar button associated with each item. The user may select such a button to indicate a desire to purchase that item. This information or purchase request is conveyed electronically to the service provider and/or the merchant at step 114, such as through the mobile device carrier.

The user continues to add desired items for purchase until the ready is ready to make a payment for the selected items. When that occurs, the user may select a button, link, or other indicator on the mobile device display to indicate to the service provider that the user is ready to make a payment. For example, the user may select a “Finish,” “Buy Now,” “Proceed to Payment,” or other suitable button, such as by tapping on the button.

The purchase or payment request is then communicated to and processed, at step 116, by the service provider; As part of the processing, the user may be requested to transmit additional information as needed, such as a user name, email address, phone number, password, PIN, etc. Note that some or all of this information may have been obtained earlier, such as through user entry or automatic transmission by the user device, so that any previously obtained information would not be needed again. This information is used by the service provider to locate the user's account and determine whether the payment can be approved. The determination may include looking at any account limitations or restrictions, such as limits set by the user and/or the service provider, and fraud analysis, such as using the user location and merchant store location. For example, if the user device and merchant store are located apart from each other (such as separated by over 100 miles), the request may be denied or further authentication by the user may be required.

After processing, the service provider may then transmit a notification to the user and/or the merchant. If the payment request is denied, the user and/or the merchant may be notified via text, email, voice, or other means, that the payment was not processed and reasons provided to the user if applicable. The user may resubmit information as needed.

If the payment request is approved, a confirmation may be sent to the merchant device and/or the user device, such as via text, email, voice, or other means. The payment provider may generate a receipt showing details of the transaction, including an indication that payment was made. The receipt may be stored on the user device and capable of being retrieved and displayed. The user may then take possession of the purchased items, such as by going to the store and showing a receipt on the mobile device, a user ID, or other confirmation of purchase. For example, the merchant may receive a confirmation ID on the merchant device, and when the user shows a corresponding ID on the user device, the merchant may release the item. In the case of a donation, the user may simply be provided an electronic receipt of the donation, which may be printable.

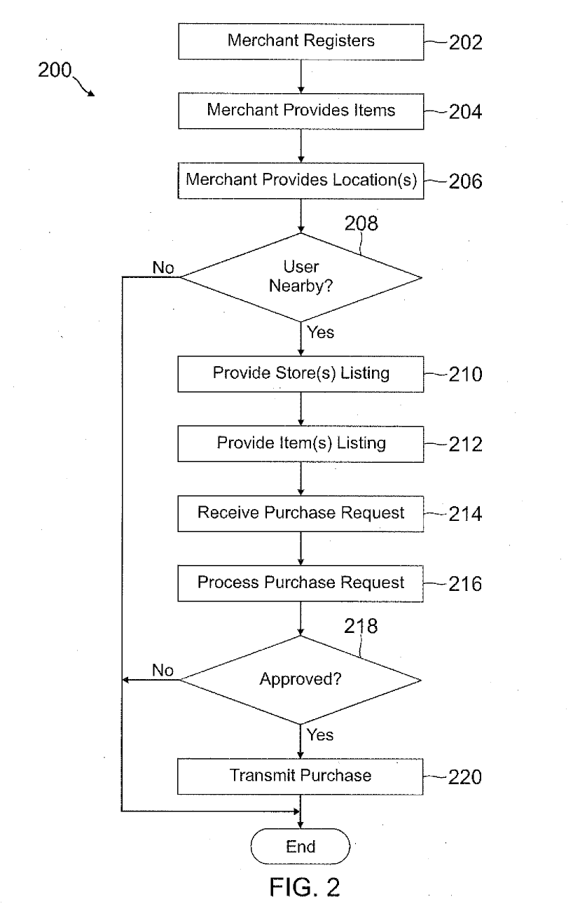

FIG. 2 is a flowchart 200 showing another embodiment of transactions using merchant and user location. In this embodiment, the “store” can be unmanned. Steps 202 through 216 are similar to steps 102 through 116 of FIG. 1, and thus, the descriptions of these steps are omitted for brevity. However, there are some notable differences, such as the items for purchase may include digital goods, such as electronic guides, games, movies, etc., and the store locations can be unmanned, such as a kiosk or vending machine. Examples include stores that are located in train stations, airports, concerts, sporting events, and any other place where space may be limited.

After the purchase request is processed at step 216, a determination is made at step 218 whether the purchase request is approved. Approval can be through a typical process, including validating or authenticating the user, the merchant, the amount of purchase, the type of purchase, the user's device, the user's location, and/or the store location, such as described above.

If the purchase request is approved, the user may receive the purchased items. In one example, the service provider transmits the purchased item (e.g., a digital good), at step 220, directly to the user's mobile device. In another example, the user may receive the purchased item from the merchant store, such as using a “bump” motion to trigger or initiate a communication between the user mobile device and the merchant store, device. Such a process is disclosed in commonly-owned U.S. patent application Ser. No. 12/570,454, filed Sep. 30, 2010, which is incorporated by reference in its entirety. Other ways to retrieve the digital goods may also be used, such as entering a code into the merchant store, where the code is received on the user mobile device when the purchase is approved.

Thus, merchants without websites or mobile merchants may take advantage of online transactions to increase sales or purchases, even at unmanned stores, such as kiosks, vending machines, and the like. Consumers may be notified of merchants in a local area of the consumer, so that consumers may easily pay and pick up items from local stores.

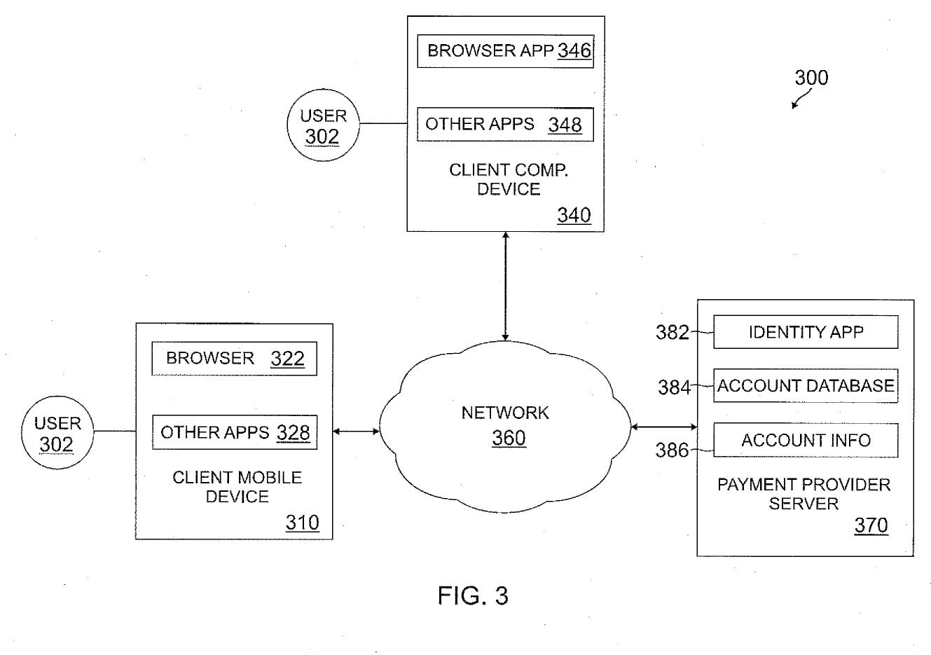

FIG. 3 is a block diagram of a networked system 300 used in shopping and making a payment through a mobile device, such as described above, according to an embodiment of the invention. System 300 includes a client device 310, a merchant device 340, and a payment service provider server 370 in communication over a network 360. Payment service provider server 370 may be maintained by a payment provider, such as PayPal, Inc. of San Jose, Calif. Server 370 may be maintained by other service providers in different embodiments.

Network 360, in one embodiment, may be implemented as a single network or a combination of multiple networks. For example, in various embodiments, network 360 may include the Internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet.

Client device 310, in one embodiment, may be implemented using any appropriate combination of hardware and/or software configured for wired and/or wireless communication over network 360. For example, client device 310 may be implemented as a smart phone of a user 302 (e.g., a client or customer) in communication with network 360. In other examples, client device 310 may be implemented as a computing tablet, a PC, personal digital assistant (PDA), notebook computer, and/or various other generally known types of wired and/or wireless computing devices. It should be appreciated that, in various embodiments, client device 310 may be referred to as a user device or a customer/client device without departing from the scope of the present disclosure.

Client device 310, in one embodiment, may include one or more browser applications 322 which may be used to provide a user interface to permit user 302 to browse information available over network 360. For example, browser application 322 may be implemented as a web browser to view information available over network 360. In one implementation, browser application 322 comprises a software program, such as a graphical user interface (GUI), executable by a processor that is configured to interface and communicate with the one or more merchant devices 340 and payment provider server 370 via network 360. For example, user 302 is able to access merchant websites to find and purchase items. User 302, through client device 310, may also communicate with payment provider server 370 to create an account and make a payment to the merchant.

As such, client device 310, in one embodiment, may include other applications 328 as may be desired in one or more embodiments to provide additional features available to user 302, including receiving available local items and making payments with payment provider server 370. For example, applications 328 may include interfaces, apps, and communication protocols that allow the user to receive and transmit information through online sites and payment provider server 370. Applications 328 may also include security applications for implementing client-side security features, programmatic client applications for interfacing with appropriate application programming interfaces (APIs) over network 360 or various other types of generally known programs and/or applications. Client device 310 may also include a location application that enables the location of the client device to be determined and conveyed to others, such as a payment provider. Such applications are commonly known.

Merchant device 340, which can be similar to client device 310, may be maintained by one or more service providers (e.g., merchant sites, auction site, marketplaces, social networking sites, etc.) offering various items, such as products and/or services, through stores created through the service provider or their websites. Merchant device 340 may be in communication with a merchant server capable of handling various on-line transactions. The merchant (which could be any representative or employee of the merchant) can process online transactions from consumers making purchases through the merchant site from mobile devices, Merchant device 340 may include purchase application 342 for offering products/services for purchase.

Merchant device 340, in one embodiment, may include a browser application 346 and other applications 348, similar to browser application 322 and applications 328 in client device 310. Browser application 346 and applications 348 enable the merchant to access a payment provider web site and communicate with payment provider server 370, such as to convey and receive information to allow the merchant to provide location and item information to the payment provider. Applications 348 may also include location-determination capabilities and interfaces to allow unmanned transactions with a user. As described in greater detail herein, embodiments of the present disclosure provide a way for merchants to sell items to or receive payments from consumers online, even when the merchant does not have a website or a manned store.

Payment provider server 370, in one embodiment, may be maintained by an online payment provider, which may provide processing for online financial and information transactions on behalf of user 302 with a merchant. Payment provider server 370 may include at least one identity application 382, which may be adapted to interact with the client device 310 and/or merchant device 340 over network 360 to facilitate the purchase of items, products and/or services by user 302, including donations made by the user.

Payment provider server 370, in one embodiment, may be configured to maintain a plurality of user and merchant accounts in an account database 384, each of which may include or be separate from an account information 386 associated with individual users, including user 302, and one or more merchants or sellers associated with one or more merchant devices 340. For example, account information 386 may include identity information of user 302 and merchants, such as one or more full names, business names, street addresses, email addresses and phone numbers, website addresses, or other types of financial information, which may be used to facilitate online transactions between user 302 and merchants. Account information or identity application may also include location information of both users and merchants and item information within specific locations of merchants. As such, payment provider server 370 may notify a user device when a user device is nearby one or more merchant locations and to provide the user device with a listing of available items for purchase at that location.

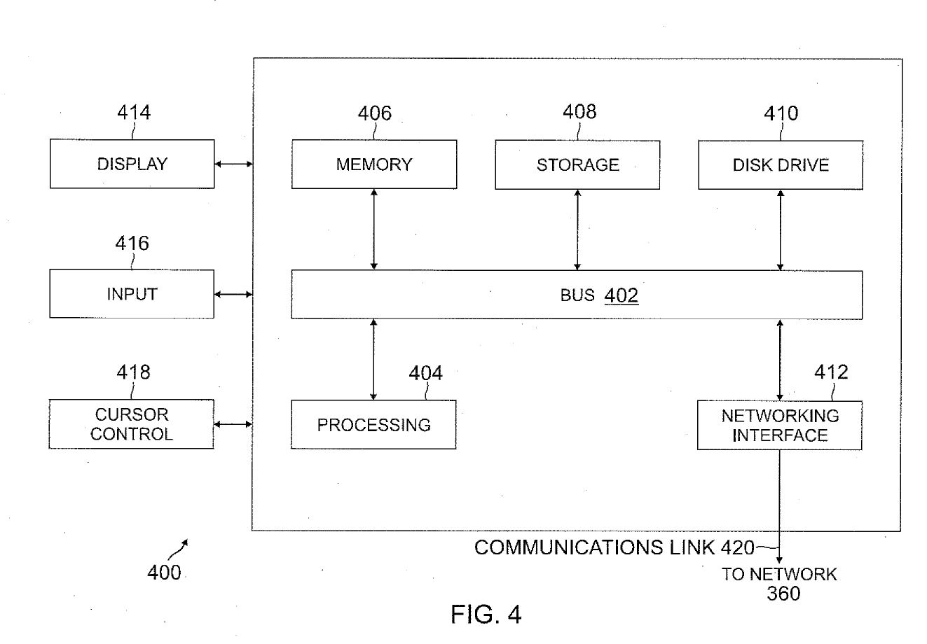

FIG. 4 is a block diagram of a computer system 400 suitable for implementing one or more embodiments of the present disclosure. In various implementations, the user and/or merchant device may comprise a personal computing device (e.g., a personal computer, laptop, smart phone, PDA, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

In accordance with various embodiments of the present disclosure, computer system 400, such as a personal computer and/or a network server, includes a bus 402 or other communication mechanism for communicating information, which interconnects subsystems and components, such as a processing component 404 (e.g., processor, micro-controller, digital signal processor (DSP), etc.), a system memory component 406 (e.g., RAM), a static storage component 408 (e.g., ROM), a disk drive component 410 (e.g., magnetic or optical), a network interface component 412 (e.g., modem or Ethernet card), a display component 414 (e.g., CRT or LCD), an input component 416 (e.g., keyboard, keypad, or virtual keyboard), and a cursor control component 418 (e.g., mouse, pointer, or trackball). In one implementation, disk drive component 410 may comprise a database having one or more disk drive components.

In accordance with embodiments of the present disclosure, computer system 400 performs specific operations by processor 404 executing one or more sequences of instructions contained in system memory component 406, such as described above with respect to the consumer, merchant, and/or payment provider in FIGS. 1 and 2. Such instructions may be read into system memory component 406 from another computer readable medium, such as static storage component 408 or disk drive component 410. In other embodiments, hard-wired circuitry may be used in place of or in combination with software instructions to implement the present disclosure.

Logic may be encoded in a computer readable medium, which may refer to any medium that participates in providing instructions to processor 404 for execution. Such a medium may take many forms, including but not limited to, non-volatile media, volatile media, and transmission media. In one embodiment, the computer readable medium is non-transitory. In various implementations, non-volatile media includes optical or magnetic disks, such as disk drive component 410, volatile media includes dynamic memory, such as system memory component 406, and transmission media includes coaxial cables, copper wire, and fiber optics, including wires that comprise bus 402. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by a communication link 420 to the network (e.g., such as a LAN, WLAN, PTSN, and/or various other wired or wireless networks, including telecommunications, mobile, and cellular phone networks) may perform instruction sequences to practice the present disclosure in coordination with one another.

Computer system 400 may transmit and receive messages, data, information and instructions, including one or more programs (i.e., application code) through communication link 420 and a communication interface 412. Network interface component 412 may include an antenna, either separate or integrated, to enable transmission and reception via communication link 420. Received program code may be executed by processor 404 as received and/or stored in disk drive component 410 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

What is claimed is:

1. A method, comprising:
receiving, by a processor of a service provider, information about a user location from a user device;
determining, by the processor, one or more stores within a specific distance to the user;
communicating, to the user device, information about the one or more stores, wherein the information comprises information about one or more items available for purchase by the user, and wherein the service provider receives the information about the one or more items from a merchant associated with at least one of the stores;
receiving, by the processor, a payment request through the user device, wherein the payment request comprises information about the merchant and one or more selected items for purchase; and
processing the request if the request is allowed as determined by the processor of the service provider.

2. The method of claim 1, wherein at least one of the one or more stores is a mobile store.

3. The method of claim 1, wherein at least one of the one or more stores is a virtual store.

4. The method of claim 1, wherein the payment request is for a charitable donation.

5. The method of claim 1, wherein at least one of the one or more stores is an unmanned store.

6. The method of claim 1, further comprising notifying the merchant and/or the user of a successful payment.

7. The method of claim 1, wherein the specific distance is set by the user.

8. The method of claim 1, wherein the specific distance is based on the location.

9. A system, comprising:
a computer storage storing account information for a plurality of users and a plurality of merchants, wherein the information for at least one of the merchants comprises information about items available for purchase provided by the merchant and location information of a merchant store having the items; and
a processor operable to:
receive information about a user location from a user device;
determine one or more stores within a specific distance to the user;
communicate, to the user device, information about the one or more stores, wherein the information comprises information about one or more items available for purchase by the user;
receive a payment request through the user device, wherein the payment request comprises information about the merchant and one or more selected items for purchase; and
process the request if the request is allowed.

10. The system of claim 9, wherein at least one of the one or more stores is a mobile store.

11. The system of claim 9, wherein the payment request is for a charitable donation.

12. The system of claim 9, wherein at least one of the one or more stores is an unmanned store.

13. The system of claim 9, wherein at least one of the one or more stores is a virtual store.

14. The system of claim 9, wherein the processor is further operable to notify the merchant and/or the user of a successful payment.

15. The system of claim 9, wherein the specific distance is set by the user.

16. The system of claim 9, wherein the specific distance is based on the location.

17. A non-transitory machine-readable medium comprising a plurality of machine-readable instructions which when executed by one or more processors of a server are adapted to cause the server to perform a method comprising:
receiving, by a service provider, information about a user location from a user device;
determining one or more stores within a specific distance to the user;
communicating, to the user device, information about the one or more stores, wherein the information comprises information about one or more items available for purchase by the user, and wherein the service provider receives the information about the one or more items from a merchant associated with at least one of the stores;
receiving a payment request through the user device, wherein the payment request comprises information about the merchant and one or more selected items for purchase; and
processing the request if the request is allowed as determined by the service provider.

18. The non-transitory machine-readable medium of claim 17, wherein at least one of the one or more stores is a mobile store.

19. The non-transitory machine-readable medium of claim 17, wherein the payment request is for a charitable donation.

20. The non-transitory machine-readable medium of claim 17, wherein at least one of the one or more stores is an unmanned store.

21. The non-transitory machine-readable medium of claim 17, wherein at least one of the one or more stores is a virtual store.

22. The non-transitory machine-readable medium of claim 17, wherein the method further comprises notifying the merchant and/or the user of a successful payment.

23. The non-transitory machine-readable medium of claim 17, wherein the specific distance is set by the user.
